(19) United States
(12) Patent Application Publication
(10) Pub. No.: US 2026/0213915 A1
(43) Pub. Date: Jul. 23, 2026

(54) ADAPTIVE RETIMING AND REPEATING SYSTEM AND METHOD FOR DYNAMIC COMMUNICATION ARCHITECTURES

(71) Applicant: MaxLinear, Inc., Carlsbad, CA (US)

(72) Inventors: Sridhar Ramesh, Carlsbad, CA (US); Curtis Ling, Carlsbad, CA (US)

(73) Assignee: MaxLinear, Inc., Carlsbad, CA (US)

(21) Appl. No.: 19/457,060

(22) Filed: Jan. 22, 2026

Related U.S. Application Data
(60) Provisional application No. 63/748,416, filed on Jan. 22, 2025.

(51) Int. Cl. H04L 7/02; H04L 12/12; H04L 41/06

(52) U.S. Cl. CPC H04L 7/02; H04L 12/12; H04L 41/06

(57) ABSTRACT

A system and method for selectively retiming signals in a high-performance network. The system includes a smart repeater circuit with input and output crossbars and retimers configured to recondition high-loss channels while bypassing low-loss channels. A sniffing mechanism dynamically assesses channel quality and adjusts routing configurations. In an advanced electrical circuit switch (AECS) system, the smart repeater integrates digital signal processors (DSPs) and analog crossbars, utilizing out-of-band (OOB) signaling for configuration, channel routing, and fault-tolerant operations. A method for channel assessment includes sequentially connecting a sniffer to input channels in a round-robin manner, evaluating channel metrics, and routing signals based on the assessments. Feedback from output channels, via in-band (IB) or OOB signaling, is used to refine routing configurations. These features support high-performance applications, providing selective retiming and dynamic signal management.

### RELATED APPLICATIONS

This application claims the benefit of U.S. Provisional Application No. 63/748,416, filed January 22, 2025, the disclosure of which is incorporated herein by reference in its entirety.

The examples discussed in the present disclosure are related to adaptive retiming and repeating system and method for dynamic communication architectures.

### BACKGROUND

Unless otherwise indicated herein, the materials described herein are not prior art to the claims in the present application and are not admitted to be prior art by inclusion in this section.

In modern network infrastructure, retimers and repeaters are components in high-speed communication systems, used to maintain signal integrity long transmission distances. A retimer is a device that restores degraded signals by reconditioning the waveform and recovering clock timing, effectively eliminating noise and jitter. Retimers are used in scenarios with high-loss channels or extended cable lengths.

A repeater, on the other hand, amplifies the signal to counteract attenuation without modifying timing characteristics. While repeaters are suitable for low-loss channels, their inability to address signal jitter limits applicability in more challenging transmission environments. Both devices aid in providing reliable, high-performance data communication, albeit with trade-offs in power consumption, latency, and cost.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

Accordingly, some examples described herein include a system and method for selectively retiming signals in high-performance networks, optimizing power efficiency and reducing latency. A smart repeater circuit includes input and output crossbars, along with retimers configured to recondition high-loss channels while bypassing low-loss channels. In some examples, the system employs a sniffing mechanism to dynamically assess channel conditions, using real-time metrics such as signal-to-noise ratio (SNR) and bit error rate (BER). Based on the assessments, the system dynamically adjusts signal routing, ensuring optimal performance for each channel.

In some examples, a smart repeater circuit is integrated within an advanced electrical circuit switch (AECS) structure. This system combines digital signal processors (DSPs), analog crossbars, and out-of-band (OOB) signaling to dynamically manage retiming, provide fault tolerance, and enable real-time updates to channel configurations.

In some examples, a method for dynamic channel assessment involves connecting a sniffer (e.g., a sniffing retime or dedicated sniffing device) to input channels in a round-robin manner. Channels requiring retiming are routed through retimers, while low-loss channels are bypassed directly. Feedback mechanisms via in-band or OOB signaling refine these routing decisions. This approach ensures efficient resource allocation, scalability, and compatibility with high-speed communication environments.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

So that the manner in which the above recited features of the present disclosure can be understood in detail, a more particular description of the disclosure, briefly summarized above, may be had by reference to examples, some of which are illustrated in the appended drawings. It is noted, however, that the appended drawings illustrate only some aspects of this disclosure and the disclosure may admit to other equally effective examples.

To facilitate understanding, identical reference numerals have been used, where possible, to designate identical elements that are common to the figures. It is contemplated that elements and features of one example may be beneficially incorporated in other examples without further recitation.

FIGS. 1A-1C illustrate schematics of an exemplary switch system, in accordance with some examples;

FIGS. 2A-2C illustrate schematic of an exemplary switch system, in accordance with some examples;

FIG. 3 illustrates a flow diagram corresponding to an exemplary switch system, in accordance with some examples;

FIG. 4 illustrates a flow diagram corresponding to an exemplary switch system, in accordance with some examples;

FIG. 5 illustrates an example communication system, in accordance with some examples; and

FIG. 6 illustrates a schematic of an exemplary computing device, in accordance with some examples.

FIG. 7A illustrates an example block diagram of a data center.

FIG. 7B illustrates an example switch device.

FIG. 7C illustrates an example switch device.

FIG. 7D illustrates an example switch device.

### DETAILED DESCRIPTION

The present disclosure will now be described in detail with reference to the drawings, which are provided as illustrative examples of the disclosure so as to enable those skilled in the art to practice the disclosure. Notably, the figures and examples below are not meant to limit the scope of the present disclosure to a single example, but other examples are possible by way of interchange of some or all of the described or illustrated elements. Moreover, where certain elements of the present disclosure can be partially or fully implemented using known components, only those portions of such known components that are necessary for an understanding of the present disclosure will be described, and detailed descriptions of other portions of such known components will be omitted so as not to obscure the disclosure.

As used herein, the singular form of “a”, “an”, and “the” include plural references unless the context clearly dictates otherwise. As used herein, the statement that two or more parts or components are “coupled” shall mean that the parts are joined or operate together either directly or indirectly (i.e., through one or more intermediate parts or components, so long as a link occurs). As used herein, “directly coupled” means that two elements are directly in contact with each other. As used herein, “fixedly coupled” or “fixed” means that two components are coupled so as to move as one while maintaining a constant orientation relative to each other. As used herein, “operatively coupled” means that two elements are coupled in such a way that the two elements function together. It is to be understood that two elements “operatively coupled” does not require a direct connection or a permanent connection between them. As utilized herein, “substantially” means that any difference is negligible, or that such differences are within an operating tolerance that are known to persons of ordinary skill in the art and provide for the desired performance and outcomes as described in one or more examples herein. Descriptions of numerical ranges are endpoints inclusive.

As used herein, the word “unitary” means a component is created as a single piece or unit. That is, a component that includes pieces that are created separately and then coupled together as a unit is not a “unitary” component or body. As employed herein, the statement that two or more parts or components “engage” one another shall mean that the parts exert a force against one another either directly or through one or more intermediate parts or components. As employed herein, the term “number” shall mean one or an integer greater than one (i.e., a plurality). Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

Embodiments described as being implemented in hardware should not be limited thereto, but can include examples implemented in software, or combinations of software and hardware, and vice-versa, as will be apparent to those skilled in the art, unless otherwise specified herein. In the examples described herein, an example showing a singular component should not be considered limiting; rather, the invention is intended to encompass other examples including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

Traditional crossbar switch systems deploy retimers universally across all channels to ensure compatibility with edge-case links exhibiting high losses. While this guarantees functionality, it imposes unnecessary power, die area, and latency penalties on the majority of low-loss links. The burgeoning need for power-efficient, high-performance solutions in data centers, PCIe interconnects, and active cable systems calls for innovation. The examples herein address these challenges by introducing a selective retiming architecture optimized for real-world applications.

The examples described herein present an adaptive retimer architecture integrated with crossbar switches to selectively apply retiming based on channel conditions. By dynamically assessing and adapting to the needs of each channel, the examples described below minimize power and latency overhead for a majority of links while maintaining high performance.

In some examples, such architecture may be beneficially applied in systems employing PCIe repeaters, DSPs for data center interconnects, pluggable optics, Active Optical Cables (AOCs), and Active Electrical Cables (AECs). For example, in some examples, the adaptive retime architecture described herein integrate seamlessly with a so-called Advanced

Electrical Circuit Switch (AECS) and enhances energy efficiency, scalability, and cost-effectiveness, which is described in detail below.

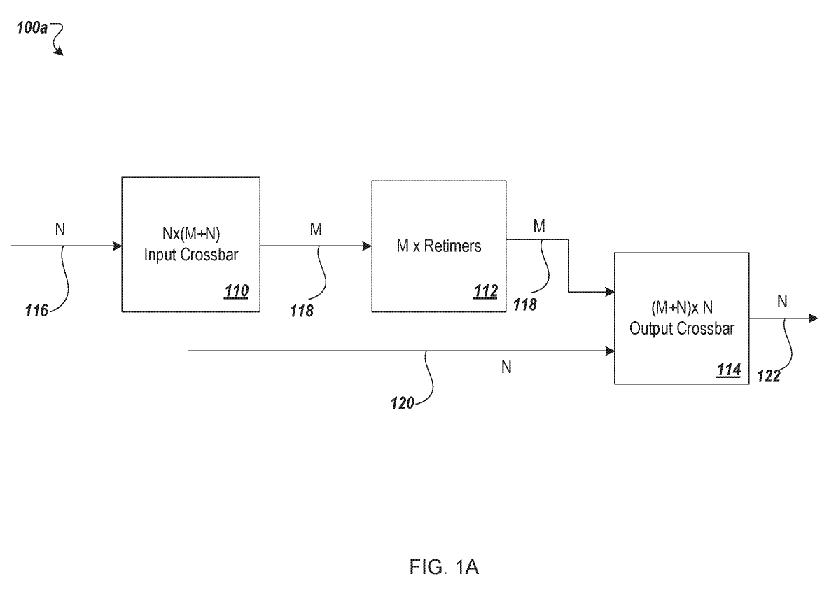

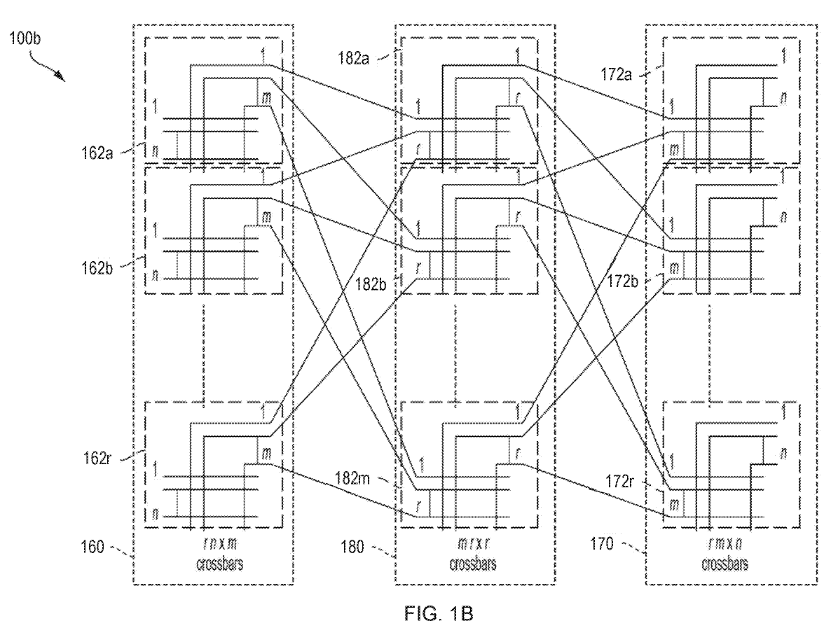

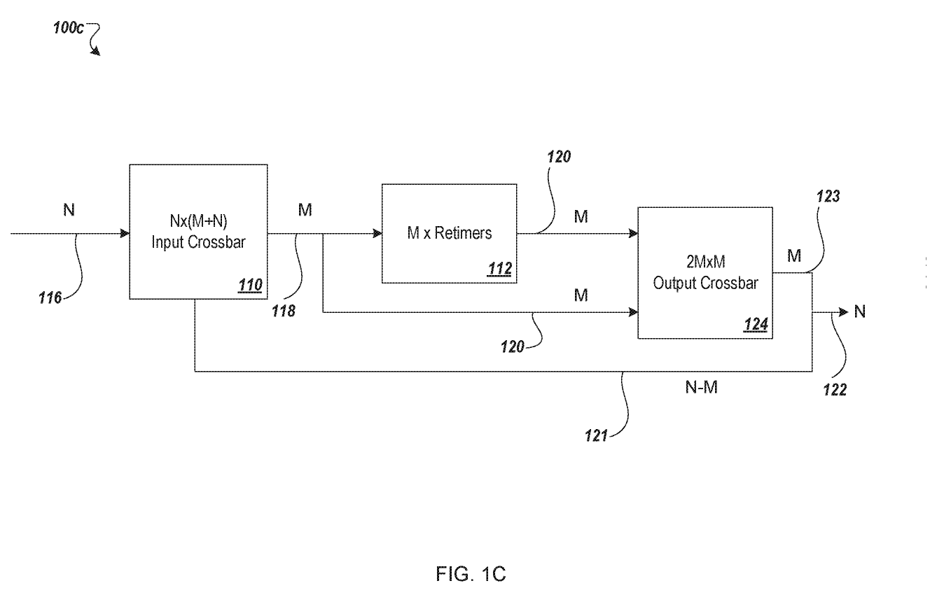

Referring now to FIGS. 1A-1C, FIGS. 1A-1C depict a schematic for implementing an adaptive retimer switch system, in accordance with some examples. As shown in FIG. 1A, in some examples, an adaptive retimer circuit (“circuit 100a”) includes input crossbar 110, retimers 112, and output crossbar 114. FIG. 1B depicts an exemplary crossbar 10, which may be employed in crossbars 110, 116, 115, in some examples. FIG. 1C depicts an adaptive retimer circuit 100c, in accordance, with some examples.

To provide further clarity on how this structure enables efficient data handling and low-latency routing, a brief review follows. FIG. 1B illustrates exemplary underlying cross bar configurations. Crossbars are specialized switching matrices that allow connections between multiple input and output ports. They enable data from any input to be dynamically routed to any output, depending on the desired data path. In high-performance network applications, crossbars support flexible and efficient data flow, especially in configurations that use dynamic routing and low latency.

FIG. 1B illustrates a schematic of interconnected crossbars 100b with n x m 160, r x r 180, and 170 m x n configurations, representing different crossbar sizes and configurations used within the system. The n x m 160 crossbars (e.g., crossbars 162a, 162b, 162r) manage initial data input, distributing data across multiple paths based on pre-determined routing rules or real-time decisions. The r x r 180 crossbars (e.g., crossbars 182a, 182b, 182m) in the center act as intermediate switching nodes, further enabling data from any input on one side to be routed to any output on the other side. These r x r 180 crossbars are advantageous for handling high data traffic within complex network structures, as they allow for extensive interconnections across potential data paths. The m x n 170 crossbars (e.g., crossbars 172a, 172b, 172r) handle the data outputs, directing data from the intermediate crossbars to the final output destinations.

The configuration depicted in FIG. 1B illustrates a flexible architecture where each input port can connect to any output port via a combination of these crossbars, providing a foundation for efficient, scalable data routing in high-capacity network systems. The interconnections between these crossbars represent the data paths established between input and output lines. Each block, or crossbar can handle multiple simultaneous connections, allowing for a high degree of flexibility in data routing.

The depicted configuration allows data to traverse multiple crossbar stages, enabling complex routing patterns and supporting high bandwidth requirements typical in modern network switches. By structuring the crossbars in this manner, the system can maintain data flow continuity and avoid congestion, even under high traffic loads. Each stage of crossbars provides additional routing options and helps optimize data flow paths across the network infrastructure.

Referring again to FIGS. 1A and 1C, circuit 100a and 100c illustrate an "adaptive retimer" architecture, which, for example, may selectively apply retiming to those channels determined based on channel quality. Retimers 112 are utilized to recondition signals on high-loss links, also referred to as "edge-case links." In contrast, low-loss channels bypass the retimers entirely, significantly reducing power consumption and latency for the majority of links.

In some examples, circuit 100a incorporates an input crossbar (110) that selects up to M paths 118 from N inputs 116 using retiming, routing these paths through the retimers (112). The remaining N-M paths 120 bypass the retimers and are routed through two analog crossbars, significantly reducing power consumption for these channels. The output crossbar (114) consolidates data for transmission to the next stage in N paths 122.

As shown in circuit 100c, the architecture minimizes resource utilization by employing a smaller 2M x M crossbar 124, which is more compact and efficient compared to an (N+M) x N crossbar 114. In practical cases, where M << N, this configuration achieves notable reductions in both power dissipation and signal loss.

In circuit 100c, the N input channels 116 may be directed to input crossbar 110 to direct m paths 118 through M x Retimers. The M x Retimer may direct m paths 120 to 2MxM output crossbar 124 to be output from m paths 123 to N paths 122. Alternatively or in addition, m paths 118 may be directed to m paths 120 to be input to 2MxM output crossbar 124 without passing through M x Retimers 112. Alternatively or in addition, N input channels 116 may be directed through input crossbar 110 then directed to N-M paths 121 to be directed to N paths 122 without passing through M x Retimers 112 or 2MxM output crossbar 124.

Some systems apply retiming universally across channels, even when unnecessary for low-loss links, resulting in penalties to power, die area, and latency. In contrast, in some examples, the adaptive retimer architecture autonomously determines which paths use retiming based on real-time channel assessments.

The assessment is performed using one of the retimers (112) as a "sniffer" to evaluate input channel conditions. In some examples, this is achieved by connecting the sniffer (e.g., a sniffing retimer or dedicated sniffing device) to the selected input paths via the input crossbar (110) without routing the path through the output crossbar (114). Discussed in detail further below, in some examples, feedback from the output channels, received via in-band (IB) signaling or out-of-band (OOB) communication (e.g., I2C or SPI protocols), is used to confirm the routing configuration.

In some examples, sniffing operations may be conducted in a round-robin duty-cycled manner, as shown in FIG. 1A, to minimize power overhead while maintaining accurate channel assessments. In some examples, the sniffer (e.g., a sniffing retimer or dedicated sniffing device) can evaluate input channels periodically, ensuring optimal system performance and adaptability.

The overall architecture, as depicted in FIGS. 1A-1C, combines dynamic routing, selective retiming, and efficient crossbar configurations to address the unique challenges of high-performance network systems. By minimizing retiming to only edge-case links and bypassing low-loss channels, the system achieves significant power and latency savings, enhancing scalability and cost efficiency for various applications.

In addition or alternatively, the architecture, depicted in FIGS. 1A and 1C, may include a 1:2 demux and a 2:1 mux and the signal may pass through a retime path or a bypass path.

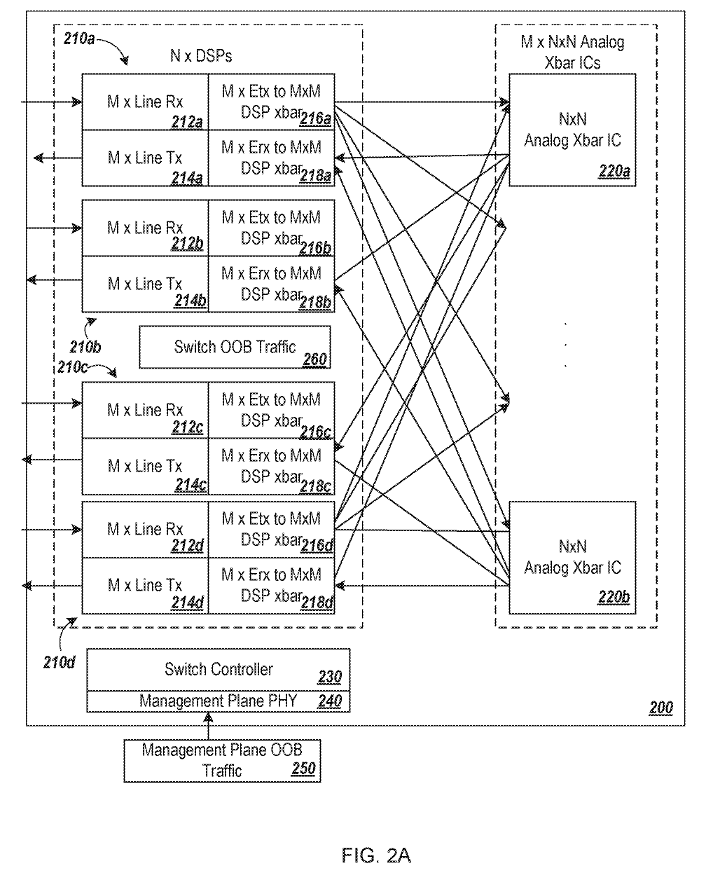

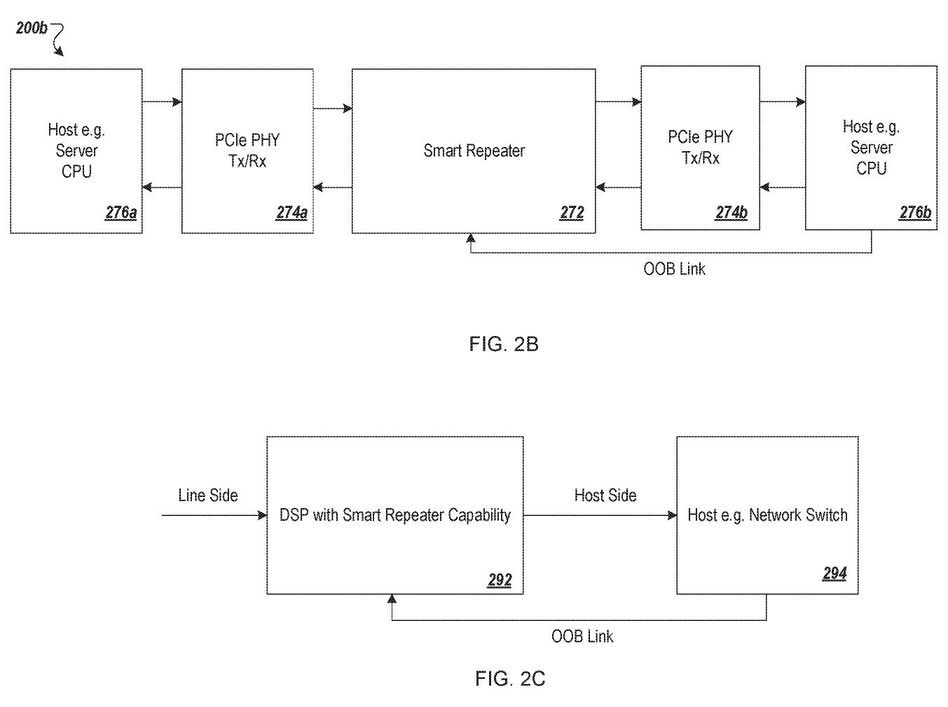

Referring now to FIG. 2A-2C, FIG. 2A illustrates an advanced electrical circuit switch (AECS) system 200 (hereinafter “system 200”). System 200 may include one or more digital signal processors (DSPs) 210a, 210b, 210c, 210d. The AECS may include a switch controller 230, a management plane physical layer, and/or management plane out-of-band (OOB) traffic 250. System 200 may include one or more analog crossbar (“xbar”) integrated circuits (IC) (e.g., analog crossbars 220a, 220b). In this example, the switch controller may be a separate component from a DSP 210a, 210b, 210c, 210d. The switch controller 230 may interface with the management plane physical layer 240. The management plane physical layer may communicate with the management plane using management plane OOB traffic 250.

In some examples, DSP 210a may include an M x Line Rx 212a, an M x Line Tx 214a, an M x ETx to MxM DSP xbar 216a, and an M x ERx to MxM DSP xbar 218a. A DSP 210b may include an M x Line Rx 212b, an M x Line Tx 214b, an M x ETx to MxM DSP xbar 216b, and an M x ERx to MxM DSP xbar 218b. A DSP 210c may include an M x Line Rx 212c, an M x Line Tx 214c, an M x ETx to MxM DSP xbar 216c, and an M x ERx to MxM DSP xbar 218c. A DSP 210d may include an M x Line Rx 212d, an M x Line Tx 214d, an M x ETx to MxM DSP xbar 216d, and an M x ERx to MxM DSP xbar 218d. A DSP xbar may be a digital crossbar integrated in the DSP.

A client may be a system communicating line-side in-band traffic to the AECS 200. For example, a server may be a system communicating line-side in-band traffic to the AECS 200. Line-side in-band (IB) bandwidth may be line traffic communicated to or from a client. IB switch traffic may be IB traffic directed into or out of or within the AECS 200. The switch controller (SC) 230 may manage and control AECS 200 devices. In one example, the switch controller 230 may be a microcontroller unit (MCU). Alternatively or in addition, the switch controller 230 may be a DSP.

In some examples, switch OOB traffic may be traffic among the SC 230, DSP 210a, 210b, 210c, 210d, analog crossbars 220a, 220b carried on a different network and physical layer than IB; may be carried on analog crossbars 220a, 220b with redundancy. An “Xbar IC” may be an analog Xbar IC which may be a chip implementing an analog crossbar with input and output lanes.

In some examples, management plane OOB traffic may be traffic from outside system 200 via management plane physical layer (PHY) to configure and manage the AECS. System 200 may utilize in-band signaling to facilitate control signaling within a payload. In-band control may be performed by allowing clients to communicate with the device via in-band bandwidth (e.g., an in-band payload) by addressing DSPs 210a, 210b, 210c, 210d and/or the switch controller 230. Packet headers and/or frame headers may be inspected by DSPs 210a, 210b, 210c, 210d for routing within the device, or for being sent to the switch controller 230.

The switch controller 230 may facilitate resource allocation. The switch controller 230 may communicate using OOB signaling to facilitate control signaling within the device. Using OOB signaling for control plane traffic may provide for management tasks that may not impact data flows. OOB wiring may include a dedicated layer from DSPs 210a, 210b, 210c, 210d to analog crossbars 220a, 120b and/or a microcontroller. The OOB wiring may be compatible with DSPs 210a, 210b, 210c, 210d by using e.g., inter-integrated circuit (I2C) and/or serial peripheral interface (SPI), another OOB input/output mode, or the like. The switch controller 230 may communicate via OOB network interface card (NIC) (e.g., using 10 Gbps Ethernet) to the datacenter.

In some examples, the control plane may manage the device using a control plane physical layer. The client may signal the device by a separate network connection carrying control plane traffic. Out-of-band signaling within the device may use a separate physical layer and connectivity for communication among DSPs 210a, 210b, 210c, 210d, analog crossbars, 220a, 220b, and/or the switch controller 230. The communication may include one or more of SPI, I2c, OOB input/output, or the like. Out-of-band signaling within the device may be used for control, management, and/or synchronization of the device.

The analog crossbars 220a, 220b (e.g., as an analog crossbar integrated circuit) may have an OOB transceiver. The OOB transceiver may communicate using one or more of SPI, I2C, 10 Gbps serializer/deserializer (SERDES), or the like. The analog crossbars 220a, 220b may be addressable using a protocol. The OOB transceiver may tap one or more of the analog crossbars 220a, 220b inputs and/or outputs. One or more of R redundant inputs may be used.

The device may include a redundant crossbar which may be used to communicate using one or more of IB signaling and/or OOB signaling when failover occurs. The redundant crossbars and/or communication paths for OOB traffic and/or IB traffic may provide for failover and/or fault tolerance in control operations.

Redundancy may allow communication to DSPs 210a, 210b, 210c, 210d without blocking IB signaling. The switch controller 230 may broadcast to DSPs 210a, 210b, 210c, 210d and/or analog crossbars 220a, 220b. The switch controller 230 may use OOB signaling to communicate with individual DSPs 210a, 210b, 210c, 210d and/or analog crossbars 220a, 220b. Time division multiplexing (TDM) and/or broadcast may be used to address a subset of DSPs 210a, 210b, 210c, 210d and/or analog crossbars 220a, 220b.

An OOB transceiver may be integrated in analog crossbars 220a, 220b and may be individually addressable and/or use TDM. One or more auxiliary IB transceivers may be included in DSPs 210a, 210b, 210c, 210d. The auxiliary IB channel may use the same physical layer as other IB channels. The auxiliary IB may use redundant analog crossbars 220a, 220b to communicate with other devices. The auxiliary IB channel may be used to deliver and/or combine IB traffic e.g., from one or more of DSPs 210a, 210b, 210c, 210d IB lanes. The auxiliary IB channel may communicate with nearest neighbors e.g., using a separate wire to connect nearest neighbor auxiliary IB lanes.

One or more redundant R lanes may be used for OOB signaling. For example, an OOB transceiver within DSPs 210a, 210b, 210c, 210d and/or within the switch controller 230 may be used for OOB signaling. The switch controller 230 may use one or more of R lanes to connect to DSPs 210a, 210b, 210c, 210d. The OOB transceiver may use a lower rate than an IB transceiver (e.g., using I2C, SPI, 10 Gbps SERDES, or the like).

Referring to FIG. 2B, the AECS system 200 may employ adaptive retimers for selective retiming of traffic between PCIe PHYs 274a, 274b and server CPUs 276a, 276b using smart repeater 272. In some examples, an adaptive retimer circuit 200b communicates with PCIe PHYs 274b and CPUs 276b via OOB links to enable adaptive configurations based on channel conditions. The OOB link allows for the exchange of control and configuration information without interfering with IB traffic, ensuring efficient system management.

Referring to FIG. 2C, a DSP with adaptive retimer capability 292 is shown, where the line-side IB traffic is routed through the DSP, and the host-side traffic is directed toward a network switch 294. In this configuration, OOB signaling facilitates real-time control and monitoring of retimer and repeater functionalities, ensuring that only the channels using retiming are processed, thereby reducing power consumption and latency for low-loss channels.

In some examples, the AECS system 200 supports high-performance applications such as PCIe repeaters, DSPs for data center interconnects, pluggable optics, Active Optical Cables (AOCs), and Active Electrical Cables (AECs). These systems may utilize an adaptive retimer design with M=N, allowing N lanes to be retimed. For example, an 8-lane DSP may incorporate an 8x8 crossbar for retiming operations, with penalties restricted to high-loss edge-case channels.

In some examples, AECS-specific DSPs may utilize reduced retiming requirements when line-side losses and switch losses are sufficiently low. In such cases, only one end of a switch connection may use retiming, further optimizing the system’s power consumption. Pluggable optics, which dominate AECS power dissipation, may benefit significantly from this selective retiming approach.

The management plane OOB traffic also facilitates device configuration and synchronization through the management plane physical layer 240. For example, OOB transceivers within the analog crossbars 220a, 220b may use SPI, I2C, or SERDES protocols to exchange control data with the switch controller 230. This enables robust management capabilities and fault tolerance, including failover operations during IB traffic disruptions.

The redundant crossbar architecture further enhances the system’s fault tolerance and reliability. As depicted in FIG. 2A, redundant crossbars within the AECS system allow for uninterrupted communication during failover events. This redundancy is extended to OOB signaling, ensuring that control traffic remains unaffected by IB traffic conditions.

In some examples, auxiliary IB transceivers within DSPs (e.g., DSPs 210a, 210b, 210c, 210d) may be used for combining IB traffic or delivering traffic to nearest neighbors via dedicated auxiliary IB lanes. This enables efficient intra-device communication, particularly for systems requiring high-speed data aggregation. The adaptive retimer design, as illustrated in FIGS. 2B and 2C, provides substantial power savings and latency reductions by selectively applying retiming only to high-loss channels. By leveraging OOB links for configuration and monitoring, the system achieves adaptive optimization across diverse applications, including high-performance computing and data center interconnects.

In some examples, the system autonomously determines which channels use retiming by employing a dynamic sniffing mechanism integrated with one or more retimers. The sniffing operation involves evaluating the signal integrity and loss conditions of individual input channels using real-time measurements. In some examples, this assessment is performed by temporarily connecting a sniffer (e.g., a sniffing retimer or dedicated sniffing device) to each channel and monitoring parameters such as signal-to-noise ratio (SNR), bit error rate (BER), or eye diagram characteristics.

Referring back to FIGS. 1A-1C in conjunction with FIG. 2A-2C, in some examples, system 100 employs the sniffer (e.g., a sniffing retimer or dedicated sniffing device) by being dynamically routed to selected input channels through the input crossbar 110. During the sniffing operation, the input crossbar routes a specific input signal to both the sniffer (e.g., a sniffing retimer or dedicated sniffing device) and the output crossbar. This dual routing ensures that regular traffic on the channel continues uninterrupted while the sniffer (e.g., a sniffing retimer or dedicated sniffing device) evaluates the channel's quality in parallel. For example, while an input channel is actively carrying data, the sniffer (e.g., a sniffing retimer or dedicated sniffing device) taps into the signal path to analyze its integrity without disrupting the primary data flow.

The sniffer (e.g., a sniffing retimer or dedicated sniffing device) collects channel quality metrics and, in some examples, communicates these metrics to the switch controller 230 via out-of-band (OOB) signaling. The metrics may include measurements of high-frequency attenuation, jitter, and reflections, which are advantageous for determining whether the channel requires retiming. In some examples, the system compares these metrics against predefined thresholds stored in the controller. Channels exceeding the thresholds are marked for retiming, while channels within acceptable limits are routed through the analog crossbar without retiming.

In some examples, the sniffing operation is performed in a round-robin duty-cycled manner to minimize power consumption. The round-robin mechanism involves sequentially connecting the sniffer (e.g., a sniffing retimer or dedicated sniffing device) to each input channel, one at a time, using the input crossbar. For example, if there are N input channels, the sniffer (e.g., a sniffing retimer or dedicated sniffing device) may assess channel 1 during one duty cycle, channel 2 during the next cycle, and so forth, until channels have been evaluated. Once the cycle is complete, the process repeats periodically to account for dynamic changes in channel conditions.

The duty cycle of the sniffing operation may be optimized based on the system's traffic patterns and channel stability. In some examples, channels with historically low losses may be evaluated less frequently, allowing the system to focus on higher-risk channels. For instance, a heavily trafficked channel with a history of degradation may be assigned a shorter interval between assessments, ensuring that any emerging issues are promptly identified and addressed.

The results of the sniffing operation may also be used to dynamically update the configuration of the input and output crossbars. For example, if a channel is identified as requiring retiming, the system may dynamically route the channel through one of the retimers 112. Conversely, channels confirmed as low-loss may be bypassed from the retimers and routed directly through the analog crossbar, thereby conserving power and reducing latency.

In some examples, the sniffer (e.g., a sniffing retimer or dedicated sniffing device) leverages feedback mechanisms to further enhance the accuracy of its assessments Feedback may be provided by the receiver side of the channel via in-band (IB) signaling or OOB communication protocols, such as I2C or SPI. The feedback loop allows the receiver to report conditions such as error rates or signal degradation back to the sniffer (e.g., a sniffing retimer or dedicated sniffing device). This information is combined with the retimer's own measurements to make more informed decisions about channel quality.

To enable seamless communication between the sniffer (e.g., a sniffing retimer or dedicated sniffing device) and the switch controller, the system incorporates an OOB transceiver within the retimer. The OOB transceiver facilitates the exchange of channel quality metrics and configuration commands over a dedicated control path, independent of the in-band data traffic. For example, once the sniffer (e.g., a sniffing retimer or dedicated sniffing device) completes an assessment, it transmits the results to the switch controller via an OOB link. The switch controller then uses this information to update routing configurations across the crossbars.

In some examples, the system employs algorithms to prioritize sniffing operations based on the operational context. For example, during periods of low traffic, the system may increase the frequency of sniffing operations to proactively identify potential issues. Conversely, during high-traffic periods, the sniffing operation may be temporarily scaled back to prioritize data throughput.

The round-robin sniffing mechanism is further enhanced by incorporating TDM for more efficient channel assessments. In some examples, the sniffer (e.g., a sniffing retimer or dedicated sniffing device) is configured to simultaneously evaluate multiple channels by rapidly switching between them within a single duty cycle. This approach minimizes the time required to complete a full cycle of assessments while maintaining the accuracy of channel evaluations.

The dynamic sniffing and round-robin mechanisms, as described herein, enable the system to maintain optimal performance across a wide range of operating conditions. By selectively retiming only those channels that use signal reconditioning, the system achieves significant power and latency savings while ensuring high signal integrity for edge-case links. These methods are particularly advantageous in high-performance environments such as data centers, PCIe interconnects, and active cable systems, where power efficiency and low latency are used.

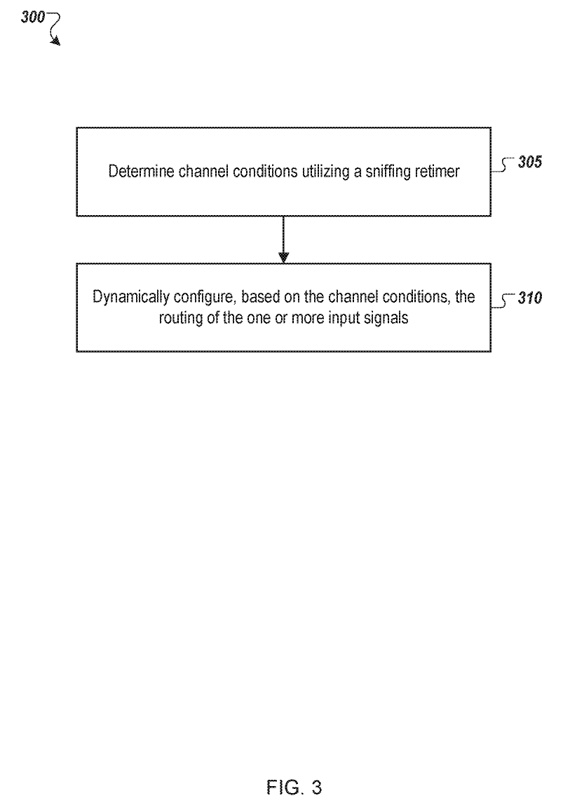

Referring now to FIG. 3, FIG. 3 illustrates a process flow of an example method 300 for selectively retiming channels in a high-performance network, as described in the present disclosure. The method 300 may be implemented by processing logic that includes hardware (e.g., circuitry, dedicated logic), software (e.g., instructions executed on a processing device), or a combination of both. The processing logic may be included in a system such as the circuit 100a of FIG. 1A, the AECS system 200 of FIG. 2A, or other suitable devices or systems.

The method 300 may begin at block 305, where the processing logic may dynamically assess or determine channel conditions utilizing a sniffer (e.g., a sniffing retimer or dedicated sniffing device). The processing logic may sequentially connect the sniffer (e.g., a sniffing retimer or dedicated sniffing device) to input channels in a round-robin manner via an input crossbar. While connected, the sniffer (e.g., a sniffing retimer or dedicated sniffing device) may evaluate channel metrics, such as signal-to-noise ratio (SNR), bit error rate (BER), and jitter, for each input channel. Based on these evaluations, the processing logic may compare the collected metrics to predefined thresholds to identify channels requiring retiming. For channels not exceeding the thresholds, the processing logic may determine that the channel can bypass retiming.

At block 310, the processing logic may dynamically configure the routing of input signals based on the assessments performed in block 305. Channels requiring retiming are routed through one or more retimers for signal reconditioning, while low-loss channels are bypassed through the input crossbar directly to an output crossbar. The processing logic may use feedback from output channels, received via in-band (IB) signaling or out-of-band (OOB) communication protocols such as I2C or SPI, to refine the routing decisions in real time. The output crossbar consolidates both retimed and bypassed signals for transmission to the next stage.

Modifications, additions, or omissions may be made to the method 300 without departing from the scope of the present disclosure. For example, the method 300 may include additional operations such as adjusting the frequency of sniffing operations based on historical channel conditions or employing TDM to assess multiple channels simultaneously. These operations may be implemented in various configurations depending on the application and system requirements.

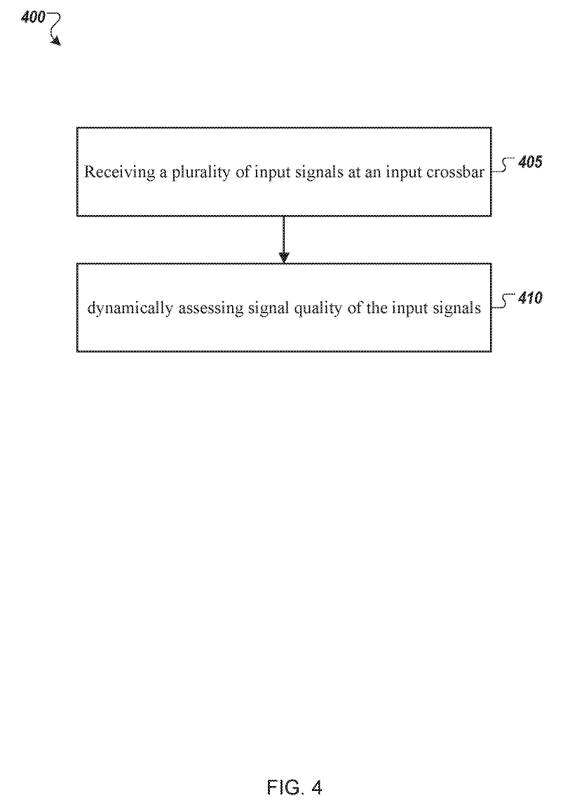

Referring now to FIG. 4, FIG. 4 illustrates a process flow of an example method 400 for selectively retiming channels in a high-performance network, as described in the present disclosure. The method 400 may be implemented by processing logic that includes hardware (e.g., circuitry, dedicated logic), software (e.g., instructions executed on a processing device), or a combination of both. The processing logic may be included in a system such as the circuit 100a of FIG. 1A, the AECS system 200 of FIG. 2A, or other suitable devices or systems.

The method 400 may begin at block 405, where the processing logic may receive a plurality of input signals at an input crossbar. The method may continue at block 410, where the processing logic may dynamically assessing signal quality of the input signals.

The processing logic may dynamically assess signal quality of the input signals by one or more of: sequentially connecting a sniffer to each input signal in a round-robin manner, wherein the sniffer evaluates channel metrics including one or more of signal-to-noise ratio (SNR), bit error rate (BER), and jitter; comparing the channel metrics to predefined thresholds to determine whether retiming is required; routing a subset of input signals exceeding the predefined thresholds through one or more retimers for reconditioning; bypassing low-loss channels directly through the input crossbar to an output crossbar without retiming; transmitting the retimed and bypassed signals through the output crossbar to corresponding output channels; receiving feedback from output channels via in-band (IB) signaling or out-of-band (OOB) communication to confirm and refine channel assessments; and dynamically reconfiguring the routing within the input and output crossbars based on the feedback.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

For example, in some examples, the feedback mechanisms integrated into the adaptive retimer architecture further enhance the precision of channel assessments. Receiver-side feedback, such as error rates, jitter analysis, and signal degradation reports, may be transmitted back to the sniffer (e.g., a sniffing retimer or dedicated sniffing device) via out-of-band (OOB) signaling protocols, including I2C, SPI, or SERDES. The sniffer (e.g., a sniffing retimer or dedicated sniffing device) combines these receiver-side metrics with its real-time channel quality measurements, such as signal-to-noise ratio (SNR) and bit error rate (BER), to make refined decisions about which channels use retiming. This integration ensures that both local and remote channel conditions are considered when configuring the input and output crossbars for optimal performance.

In some examples, for further enhancing power efficiency, the adaptive retimer architecture employs dynamic duty cycle adjustment for sniffing operations. Channels with historically stable metrics are assigned longer intervals between assessments, while channels with frequent fluctuations or high traffic loads are evaluated more frequently. For example, during periods of low traffic, the sniffer (e.g., a sniffing retimer or dedicated sniffing device) may operate at a reduced frequency to conserve power, focusing on historically problematic channels. Conversely, during high-traffic periods, the duty cycle may increase for channels showing early signs of degradation, allowing the system to proactively address emerging issues without compromising overall throughput.

The above-described architecture is designed to scale seamlessly for high-speed communication protocols such as PCIe Gen 4/5/6, Ethernet, and Infiniband. The modular design of the input and output crossbars, coupled with the round-robin sniffing mechanism, ensures compatibility with systems requiring up to 128 or more lanes. For example, the architecture can support advanced PCIe implementations by incorporating adaptive retimingor edge-case lanes without affecting the performance of low-loss links, making it suitable for high-performance computing and data center environments.

In some examples, the redundant crossbars and OOB transceivers are configured to maintain seamless operation during failover events. When a fault is detected in one of the input or output channels, the system dynamically reroutes the affected channel through the redundant crossbar without disrupting ongoing data transmission. The OOB transceivers monitor the status of active and redundant links, ensuring that the system can instantly switch to backup paths, preserving both control signaling and data flow integrity.

In some examples, in addition to assessing channel conditions, the sniffer (e.g., a sniffing retimer or dedicated sniffing device) may include error detection and correction functionality. For instance, during the sniffing operation, the retimer can identify patterns indicative of impending errors, such as excessive jitter or high-frequency attenuation. The system may then preemptively apply signal reconditioning or rerouting measures to mitigate potential errors before they propagate, ensuring uninterrupted communication across channels.

In some examples, system 200 supports dynamic resource allocation for multi-traffic environments. For example, during simultaneous high-bandwidth and low-latency traffic flows, the adaptive retimer selectively prioritizes low-latency channels for immediate retiming, while buffering high-bandwidth channels for subsequent processing. This capability enables efficient resource utilization in data center interconnects, active cable systems, and other high-demand scenarios.

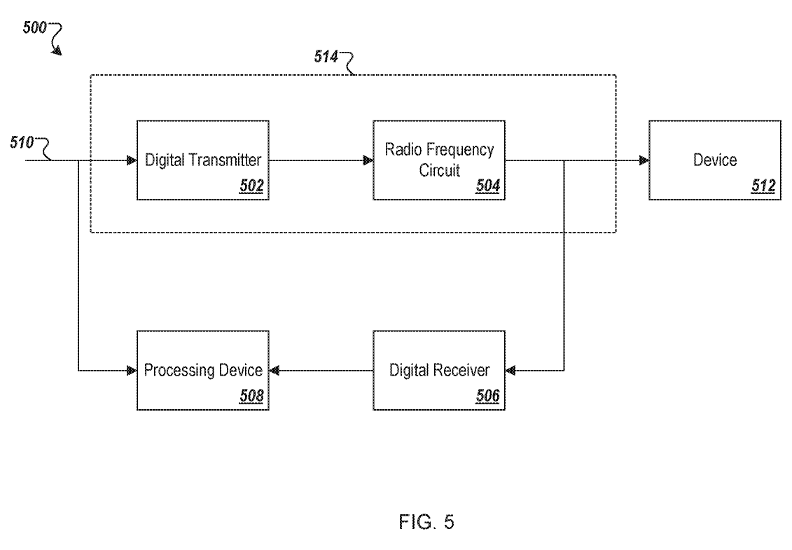

FIG. 5 illustrates a block diagram of an example communication system 500 configured for time division multiplexing, in accordance with at least one example described in the present disclosure. The communication system 500 may include a digital transmitter 502, a radio frequency circuit 504, a device 512, a digital receiver 506, and a processing device 508. The digital transmitter 502 and the processing device may be configured to receive a baseband signal via connection 510. A transceiver 514 may comprise the digital transmitter 502 and the radio frequency circuit 504.

In some examples, the communication system 500 may include a system of devices that may be configured to communicate with one another via a wired or wireline connection. For example, a wired connection in the communication system 500 may include one or more Ethernet cables, one or more fiber-optic cables, and/or other similar wired communication mediums. Alternatively, or additionally, the communication system 500 may include a system of devices that may be configured to communicate via one or more wireless connections. For example, the communication system 500 may include one or more devices configured to transmit and/or receive radio waves, microwaves, ultrasonic waves, optical waves, electromagnetic induction, and/or similar wireless communications. Alternatively, or additionally, the communication system 500 may include combinations of wireless and/or wired connections. In these and other examples, the communication system 500 may include one or more devices that may be configured to obtain a baseband signal, perform one or more operations to the baseband signal to generate a modified baseband signal, and transmit the modified baseband signal, such as to one or more loads.

In some examples, the communication system 500 may include one or more communication channels that may communicatively couple systems and/or devices included in the communication system 500. For example, the transceiver 514 may be communicatively coupled to the device 512.

In some examples, the transceiver 514 may be configured to obtain a baseband signal. For example, as described herein, the transceiver 514 may be configured to generate a baseband signal and/or receive a baseband signal from another device. In some examples, the transceiver 514 may be configured to transmit the baseband signal. For example, upon obtaining the baseband signal, the transceiver 514 may be configured to transmit the baseband signal to a separate device, such as the device 512. Alternatively, or additionally, the transceiver 514 may be configured to modify, condition, and/or transform the baseband signal in advance of transmitting the baseband signal. For example, the transceiver 514 may include a quadrature up-converter and/or a digital to analog converter (DAC) that may be configured to modify the baseband signal. Alternatively, or additionally, the transceiver 514 may include a direct radio frequency (RF) sampling converter that may be configured to modify the baseband signal.

In some examples, the digital transmitter 502 may be configured to obtain a baseband signal via connection 510. In some examples, the digital transmitter 502 may be configured to up-convert the baseband signal. For example, the digital transmitter 502 may include a quadrature up-converter to apply to the baseband signal. In some examples, the digital transmitter 502 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 502.

In some examples, the transceiver 514 may include one or more subcomponents that may be used in preparing the baseband signal and/or transmitting the baseband signal. For example, the transceiver 514 may include an RF front end (e.g., in a wireless environment) which may include a power amplifier (PA), a digital transmitter (e.g., 502), a digital front end, an Institute of Electrical and Electronics Engineers (IEEE) 1588v2 device, a Long-Term Evolution (LTE) physical layer (L-PHY), an (S-plane) device, a management plane (M-plane)

device, an Ethernet media access control (MAC)/personal communications service (PCS), a resource controller/scheduler, and the like. In some examples, a radio (e.g., a radio frequency circuit 504) of the transceiver 514 may be synchronized with the resource controller via the S-plane device, which may contribute to high-accuracy timing with respect to a reference clock.

In some examples, the transceiver 514 may be configured to obtain the baseband signal for transmission. For example, the transceiver 514 may receive the baseband signal from a separate device, such as a signal generator. For example, the baseband signal may come from a transducer configured to convert a variable into an electrical signal, such as an audio signal output of a microphone picking up a speaker’s voice. Alternatively, or additionally, the transceiver 514 may be configured to generate a baseband signal for transmission. In these and other examples, the transceiver 514 may be configured to transmit the baseband signal to another device, such as the device 512.

In some examples, the device 512 may be configured to receive a transmission from the transceiver 514. For example, the transceiver 514 may be configured to transmit a baseband signal to the device 512.

In some examples, the radio frequency circuit 504 may be configured to transmit the digital signal received from the digital transmitter 502. In some examples, the radio frequency circuit 504 may be configured to transmit the digital signal to the device 512 and/or the digital receiver 506. In some examples, the digital receiver 506 may be configured to receive a digital signal from the RF circuit and/or send a digital signal to the processing device 508.

In some examples, the processing device 508 may be a standalone device or system, as illustrated. Alternatively, or additionally, the processing device 508 may be a component of another device and/or system. For example, in some examples, the processing device 508 may be included in the transceiver 514. In instances in which the processing device 508 is a standalone device or system, the processing device 508 may be configured to communicate with additional devices and/or systems remote from the processing device 508, such as the transceiver 514 and/or the device 512. For example, the processing device 508 may be configured to send and/or receive transmissions from the transceiver 514 and/or the device 512. In some examples, the processing device 508 may be combined with other elements of the communication system 500.

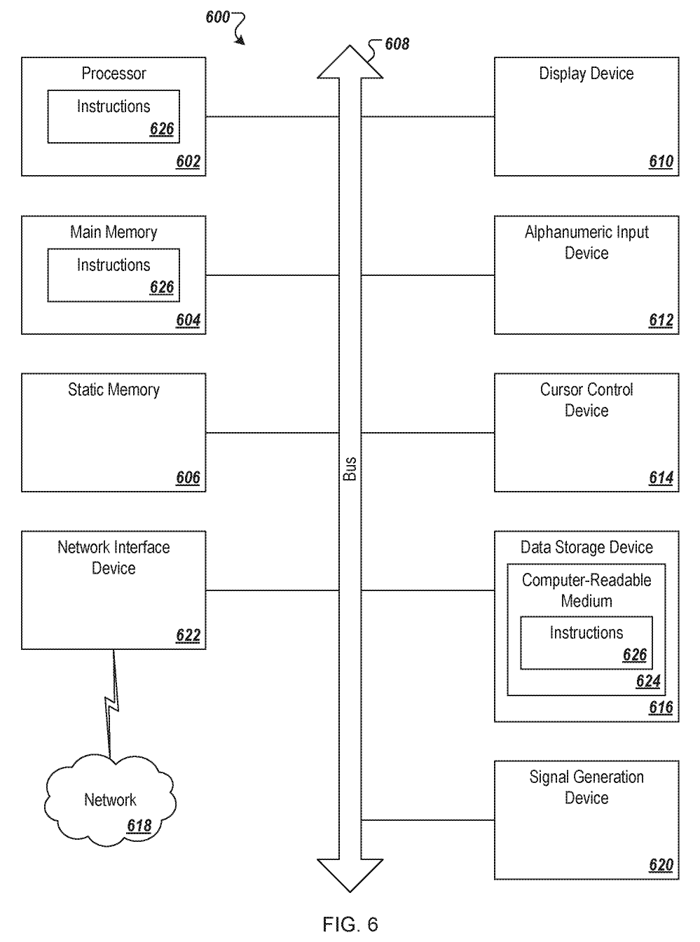

FIG. 6 illustrates a diagrammatic representation of a machine in the example form of a computing device 600 within which a set of instructions, for causing the machine to perform any one or more of the methods discussed herein, may be executed. The computing device 600 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 600 includes a processing device (e.g., a processor) 602, a main memory 604 (e.g., read-only memory (ROM), flash memory, dynamic random access memory (DRAM) such as synchronous DRAM (SDRAM)), a static memory 606 (e.g., flash memory, static random access memory (SRAM)) and a data storage device 616, which communicate with each other via a bus 608.

Processing device 602 represents one or more general-purpose processing devices such as a microprocessor, central processing unit, or the like. More particularly, the processing device 602 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 may also include one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein.

The computing device 600 may further include a network interface device 622 which may communicate with a network 618. The computing device 600 also may include a display device 610 (e.g., a liquid crystal display (LCD) or a cathode ray tube (CRT)), an alphanumeric input device 612 (e.g., a keyboard), a cursor control device 614 (e.g., a mouse) and a signal generation device 620 (e.g., a speaker). In at least one example, the display device 610, the alphanumeric input device 612, and the cursor control device 614 may be combined into a single component or device (e.g., an LCD touch screen).

The data storage device 616 may include a computer-readable storage medium 624 on which is stored one or more sets of instructions 626 embodying any one or more of the methods or functions described herein. The instructions 626 may also reside, completely or at least partially, within the main memory 604 and/or within the processing device 602 during execution thereof by the computing device 600, the main memory 604 and the processing device 602 also constituting computer-readable media. The instructions may further be transmitted or received over a network 618 via the network interface device 622.

While the computer-readable storage medium 624 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

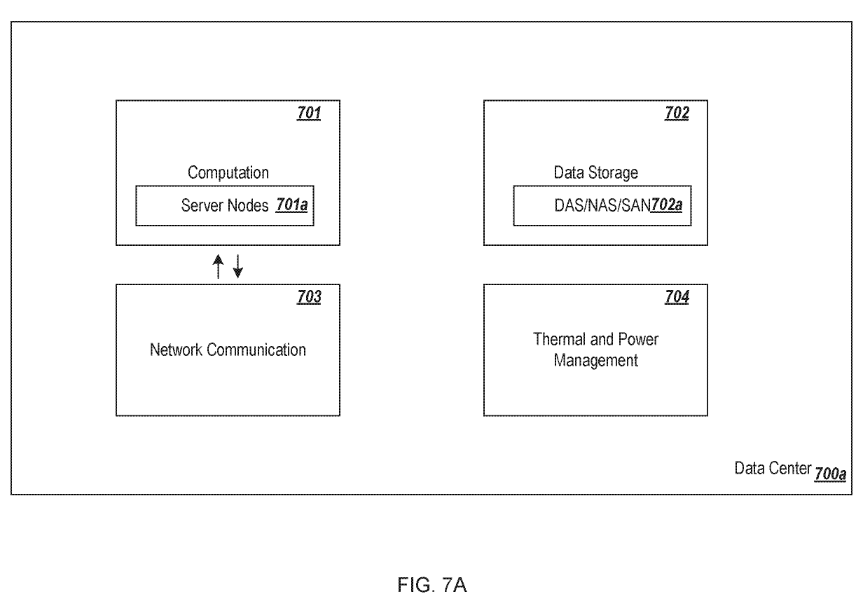

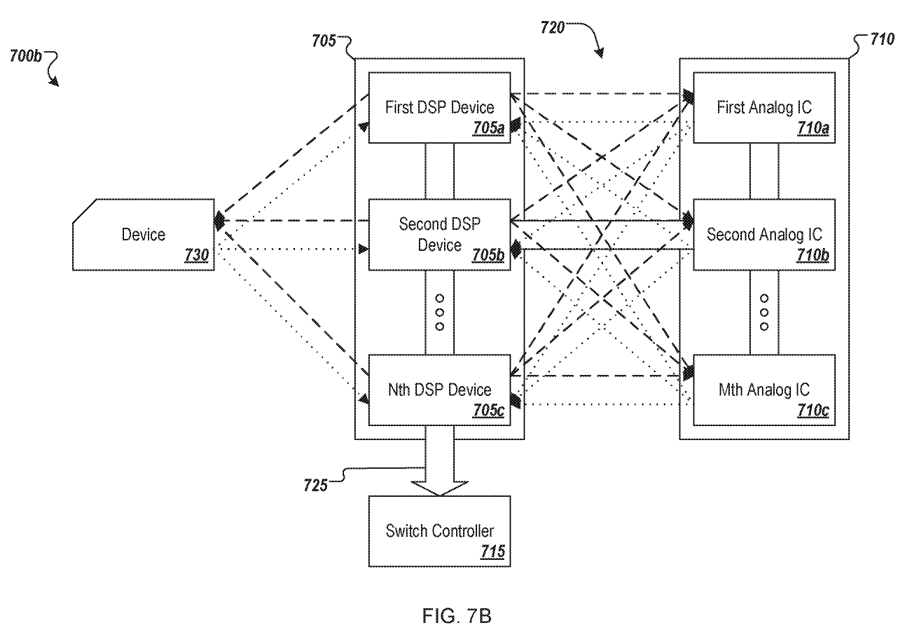

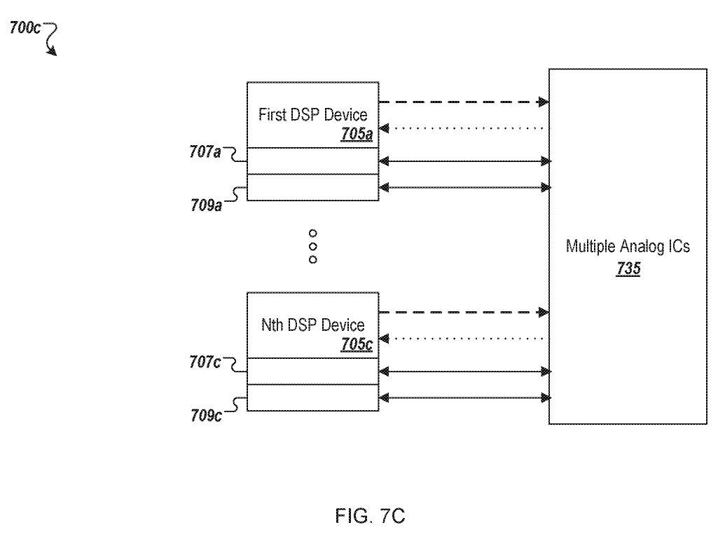

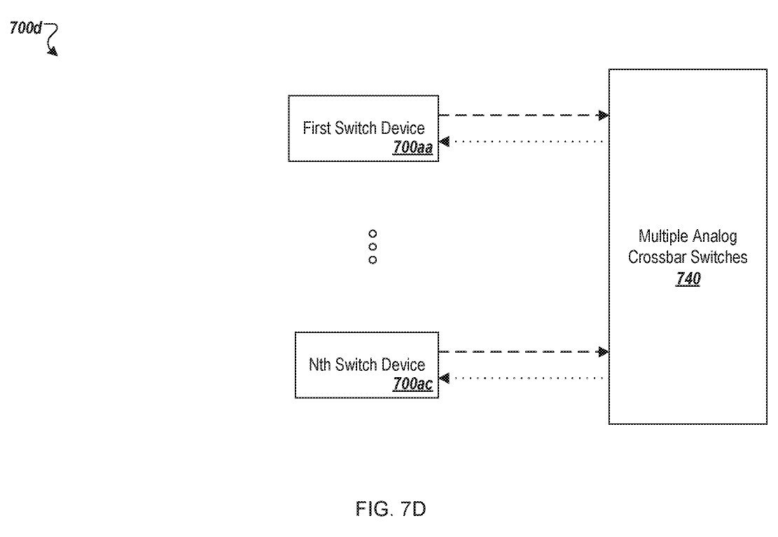

As illustrated in FIG. 7, a block diagram of a data center 700a may include multiple subsystems configured to perform various operational functions, including computation 701, data storage 702, network communication 703, and thermal and power management 704. The computation 701 subsystem may include one or more server nodes 701a that may execute software applications and process data workloads. The data storage 702 subsystem may provide persistent data retention through devices such as hard disk drives, solid-state drives, or distributed storage arrays, which may be organized in configurations such as Direct Attached Storage (DAS), Network Attached Storage (NAS), or Storage Area Networks (SAN) 702a. The networking communication 703 subsystem may facilitate bidirectional data transfer between servers and external networks through high-speed switching and routing components. The thermal and power management 704 subsystem may maintain operational integrity by regulating temperature and supplying uninterrupted electrical power, e.g., through redundant power sources and cooling mechanisms. Each subsystem may operate in coordination to ensure continuous availability, scalability, and fault tolerance and the ability to scale up and scale out in response to increasing computational and storage demands.

The architecture of a data center 700a may include multiple physical and logical components that collectively enable high-performance computing and data handling. The compute layer may include server racks populated with processors optimized for general-purpose or specialized workloads, including central processing units (CPUs), graphics processing units (GPUs), and field-programmable gate arrays (FPGAs). The storage layer may incorporate hierarchical storage systems that may employ high-speed interfaces such as Non-Volatile Memory Express (NVMe) to reduce latency. The networking layer may use top-of-rack switches, aggregation switches, and core routers arranged in various topologies, (e.g., crossbar, Clos, leaf-spine, etc.) to provide non-blocking connectivity and minimize hop count between endpoints. Power distribution units (PDUs), uninterruptible power supplies (UPS), and backup generators may form the electrical infrastructure, while cooling systems may employ air-based or liquid-based heat dissipation techniques to maintain thermal stability. These components may be integrated to achieve high reliability, modular scalability, and compliance with performance requirements, enabling the system to scale up and scale out as operational loads increase.

In operation, a data center may process client requests through a multi-stage workflow that includes traffic distribution, application execution, and data retrieval. Incoming requests may be received by a load balancing system configured to allocate workloads across multiple compute nodes to prevent resource saturation. Application servers may execute the requested operations, which may involve accessing structured or unstructured data stored within the storage subsystem. Virtualization technologies may enable multiple virtual machines to operate on a single physical server, thereby optimizing resource utilization Containerization frameworks, such as those implementing Linux containers, may provide isolated execution environments for microservices and facilitate rapid deployment across heterogeneous hardware. The networking subsystem may ensure deterministic packet routing and congestion management through high-speed interconnects and software-defined networking protocols. This operational workflow may be designed to maintain low latency, high throughput, and fault-tolerant performance under variable load conditions, while supporting the ability to scale up and scale out dynamically.

Conventional data center implementations may exhibit several advancements aimed at improving efficiency, scalability, and sustainability. Hyperscale architectures may employ large-scale server clusters interconnected through high-bandwidth fabrics to support cloud computing and artificial intelligence workloads. Edge computing deployments may position micro data centers proximate to end-user devices to reduce network latency and enable real-time processing. Specialized accelerators, including GPUs and tensor processing units (TPUs), may be increasingly integrated to support machine learning and high-performance computing applications. Energy efficiency initiatives may incorporate renewable energy sources and advanced cooling methodologies, such as liquid immersion cooling, to reduce operational costs and environmental impact. These trends reflect an industry-wide transition toward architectures that may be highly distributed, workload-optimized, and environmentally sustainable.

A scale-up network architecture may be characterized by the addition of resources within a single network node or chassis to increase capacity. In such configurations, performance improvements may be achieved by augmenting the processing capability, memory, or port density of an existing switch or router. This approach may involve deploying high-capacity modular switches with vertically integrated backplanes and high-bandwidth switch fabrics. The scale-up model may be advantageous for environments having centralized control and minimal inter-node latency, as traffic may be processed within a single logical device.

A scale-out network architecture may be characterized by the horizontal expansion of network capacity through the addition of multiple interconnected nodes. In this configuration, performance and scalability may be achieved by distributing workloads across multiple switches, for example arranged as a leaf-spine architecture. Each leaf switch may provide connectivity to compute and storage resources, while spine switches interconnect the leaf layer to form a non-blocking, high-bandwidth fabric. The scale-out model may enable incremental capacity expansion without completely replacing existing infrastructure, thereby supporting elastic growth and fault tolerance. This architecture may be particularly suited for large-scale data centers and cloud environments, where traffic patterns may be highly distributed and use predictable bandwidth. Scale-out networks may leverage parallelism and redundancy to achieve near-linear scalability.

A scale-up network may carry information, including AI training and inference algorithms, among computing units (such as graphics processing units (GPUs)). These networks may have various characteristics such as high bandwidth (e.g., non-blocking all-to-all bandwidth), low latency (e.g., minimize layers of switching and per-switch latency), and scalability (e.g., supporting high numbers of interconnected GPUs and low energy per bit transferred through network). For purposes of this disclosure, a “GPU” has been provided as an example and instances of GPU may be substituted by any type of processor such as CPUs, ASICs, or the like.

Conventional scale-up networks may centralize the switching/routing function in order to scale GPU connectivity across multiple rack units and even multiple racks. An example compute rack may include 18 compute trays consuming about 6kW each, and 9 switch trays consuming about 1kW each. Each GPU may have 18 ports of 100GB/s each (or 1.8TB/s per GPU), and the rack network (which may be implemented using a copper backplane) may connect each GPU to the 9 switch trays to provide each GPU with the ability to deliver all of its 1.8TB/s to any other GPU in the rack, a capability often referred to as “All-to-All bandwidth”. This may be used for parallelizing the computation of an AI model for training or inference purposes.

This rack-level power density may be quite high and push the limit of electrical power and thermal cooling densities, leaving little room for additional compute trays. Furthermore, switch connectivity for all-to-all crossbar-like functionality has complexity and power which may vary quadratically with the number of ports being interconnected, so scaling the GPUs connected within a rack may be constrained, even when the number of GPUs may be increased.

A centralized full crossbar may be replaced with distributed crossbars which places ultra-efficient, ultra-low-latency analog crossbars locally with their respective GPUs, and routes them to digital switch SOCs with an arrangement of crossbars which may be simplified compared with full crossbars. This may drive improvements in network power, latency, complexity, and scalability.

As a result, network traffic (e.g., which may be AI traffic) may be matched with low predictable latency providing all-to-all bandwidth. Compared to Ethernet packet switches, 1/5 of the power may be consumed. The device may be capable of high radix implementations (e.g., 1024 lanes). The device may be usable in all-copper backplane scale ups as well as with multi-mode (MM) fiber.

Thus, the examples described herein present systems and methods for an Advanced Electrical Circuit Switch (AECS) switch capable of ultra-low-latency (e.g., <5ns, 10 ns, or the like) and low-power switching across a flexible any-to-any crossbar architecture. The AECS switch eliminates internal buffering and packet inspection within the crossbar, allowing for a highly efficient and scalable architecture. A programmable crossbar configuration may dynamically map input ports to output ports in response to real-time traffic conditions.

An example system may include advanced control mechanisms for broadcasting and multicasting data from a single input to multiple outputs, optimizing resource allocation and minimizing overhead. Make-before-break (MBB) protocols may be employed to ensure seamless reconfiguration of crossbar connections without data loss, even during high-speed operations. Additionally, adaptive equalization techniques may be integrated into the system, allowing the AECS to optimize signal quality based on feedback from connected devices.

An architecture may include redundancies along with digital signal processors (DSPs) configured to support any-to-any connections. In such an arrangement, low-latency switching along with low power use per lane may be achieved. Further, memory included in the DSPs may be used for any storage or buffering and each of the components included in the switch may include redundant lanes such that degradations or broken DSPs may be rerouted around and replaced without losses to the system. The reconfiguration in the switch may be dynamically performed (e.g., such as in view of real-time traffic managed by the switch) by a switch controller that may communicate with the components in the switch using out-of-band traffic so as to not interfere with the in-band communications otherwise being handled by the switch.

FIG. 7B illustrates an example switch device 700b. The switch device 700b may include a first digital signal processor (DSP) device 705a, a second DSP device 705b, an nth DSP device 705c, referred to collectively as multiple first electronic devices 705, a first analog integrated circuit (IC) 710a, a second analog IC 710b, an mth analog IC 710c, referred to collectively as multiple second electronic devices 710, a switch controller 715, in-band traffic 720, and out-of-band traffic 725. First DSP 705a, second DSP 705b, and nth DSP 705c may have input and output as shown in greater detail with respect to FIG. 2.

The switch device 700b may be reconfigurable (e.g., in terms of the connections between the components therein, such as the multiple first electronic devices 705 and the multiple second electronic devices 710, the switch controller 715, and/or a device 730), where the switching of the connections/lanes between the components may be low latency (e.g., less than 5 ns, 10ns, or the like switching). Alternatively, or additionally, the switch device 700b may reconfigure without the use of retiming such that each lane of the multiple lanes included therein may use less than 50 mW of power. For example, each lane of the multiple lanes may support 100G bandwidth while using less than 50 mW of power.

The multiple first electronic devices 705 may individually include one or more ports that may be used to facilitate communications within the switch device 700b, such as between the multiple first electronic devices 705 and the multiple second electronic devices 710, the switch controller 715, and/or a device 730. The communications in the switch device 700b may be transmitted via multiple lanes in the switch device 700b. The multiple lanes may facilitate the in-band traffic 720 and/or the out-of-band traffic 725.

The multiple lanes between the multiple first electronic devices 705 and the multiple second electronic devices 710 may be in an any-to-any configuration. For example, the first DSP device 705a may include a lane to the first analog IC 710a, to the second analog IC 710b, and/or the mth analog IC 710c. A similar arrangement may occur for each of the multiple first electronic devices 705, such that each DSP device of the multiple first electronic devices 705 may include a lane to any number of the multiple second electronic devices 710, including none of the multiple second electronic devices 710. As illustrated in FIG. 7, each lane for facilitating the in-band traffic 720 may be in both directions (e.g., transmit and receive) between the multiple first electronic devices 705, the multiple second electronic devices 710, and/or a device 730. Alternatively, or additionally, the lanes are dashed/dotted to illustrate that for any transmit/receive path between the multiple first electronic devices 705, the multiple second electronic devices 710, and/or a device 730, a lane may or may not be present.

The multiple first electronic devices 705, the multiple second electronic devices 710, and/or the switch controller 715 may be disposed on a printed circuit board (PCB) where traces on the PCB may be used to connect at least the multiple first electronic devices 705, the multiple second electronic devices 710, and/or the switch controller 715 (e.g., the traces on the PCB may facilitate the in-band traffic 720 and/or the out-of-band traffic 725 in the switch device 700b). Alternatively, or additionally, the multiple first electronic devices 705, the multiple second electronic devices 710, and/or the switch controller 715 may be connected to one another using connectors, such as high-speed cables, where the multiple first electronic devices 705, the multiple second electronic devices 710, and/or the switch controller 715 may individually include ports/headers to support the use of the connectors. In instances in which the connectors are used, crosstalk between the multiple lanes in the switch device 700b may be reduced relative to the crosstalk that may occur when the switch device 700b uses traces on a PCB.

The switch device 700b, including the multiple first electronic devices 705, the multiple second electronic devices 710, and/or the switch controller 715, may be utilized with one or more additional switches and/or crossbar devices to form a new crossbar switch device, which may be larger than any one of the switch devices 700b. For example, as illustrated and discussed relative to FIG. 7C, the switch device 700b may be utilized with any other number of switch devices 700b (e.g., the nth switch device 700ac in FIG. 7C) and multiple analog crossbar switches 740 to form a new crossbar switch device.

The multiple first electronic devices 705 may be digital signal processors (DSPs) and/or the multiple second electronic devices 710 may be analog circuit switch integrated circuits (ICs) for use with electrical signals. Alternatively, or additionally the multiple second electronic devices 710 may be analog optical circuit switch ICs for use with optical signals. The multiple first electronic devices 705 may be individually configured to support one or more layer of the open systems interconnection (OSI) model. For example, each of the multiple first electronic devices 705 may be configured to support layer 1 protocols, layer 2 protocols, and/or layer 3 protocols with respect to the in-band traffic 720 and/or the out-of-band traffic 725.

Each, or at least one, of the multiple first electronic devices 705 may support layer 1 protocols, which may include detecting and/or processing layer 2 protocols and/or layer 3 protocols, handling layer 2 protocol and/or layer 3 protocol addressability, frame header detection, packet header inspection, responding to layer 2 protocol and/or layer 3 protocol requests, storing information in response to a request associated with layer 2 protocols and/or layer 3 protocols, updating information in response to a request associated with layer 2 protocols and/or layer 3 protocols, communicating information in response to a request associated with layer 2 protocols and/or layer 3 protocols, optimizing information in response to a request associated with layer 2 protocols and/or layer 3 protocols, etc. Each of the multiple first electronic devices 705 may be able to adjust the way in which traffic is directed through it, such as in response to a command from the switch controller 715. For example, each of the multiple first electronic devices 705 may be operable to configure an internal switch, an external switch, or a crossbar based on the various layer protocol processing to be performed.

The first DSP device 705a may receive a communication that includes a frame header (or a packet header) and the first DSP device 705a may be configured to detect the frame header and decode the frame header along with any associated contents of the communication, within the first DSP device 705a. In a second example, the first DSP device 705a may integrate a media access control (MAC) address lookup table which may allow the first DSP device 705a to configure one or more crossbars such that the first DSP device 705a may facilitate connectivity between any two MAC addresses that are included in the lookup table. Alternatively, or additionally, each of the first electronic devices 705 may include a lookup table that may store equalization settings that may be used for various connections between the first electronic devices 705 and other components within the switch device 700b. The equalization settings in the lookup table may be used to accelerate acquisition and/or tracking for a particular DSP device of the multiple first electronic devices 705 when the particular DSP device switches connections within the switch device 700b.

The multiple first electronic devices 705 may be configured to respond to layer 2 protocol requests and/or layer 3 protocol requests for connectivity and/or resource grant requests. For example, the multiple first electronic devices 705 may compare a request to a lookup table that includes priority levels and the multiple first electronic devices 705 may be operable to configure themselves and/or associated crossbars and/or switches based on the determined priority level. Alternatively, or additionally, each of the multiple first electronic devices 705 may be configured to respond to in-band requests (e.g., granting a connection request, signaling backpressure to the device 730, etc.), collect statistics on traffic handled by the multiple first electronic devices 705 (e.g., link utilization and/or traffic type), and/or perform data filtering (e.g., detecting a particular header, performing routing, generating flags and/or interrupts, and/or logging any of the filtering events).

The multiple first electronic devices 705 may be configured to communicate with (e.g., transmit data to and/or receive data from) the device 730. The communication with the device 730 may include in-band traffic 720. In such instances, the communications between the multiple first electronic devices 705 and the device 730 may be line-side communications, where the lines may facilitate communications using various communication channels. For example, the line-side communications between the multiple first electronic devices 705 and the device 730 may be an electrical-to-electrical connection, an optical-to-optical connection, an electrical-to-optical connection, or an optical-to-electrical connection, and so forth.

The device 730 may address communications directly to one of the multiple first electronic devices 705. For example, the device 730 may address communications to the second DSP device 705b. Alternatively, or additionally, the device 730 may address communications to the switch controller 715, which may then direct communications to the appropriate DSP device. For example, the device 730 may address communications intended for the second DSP device 705b to the switch controller 715 and the switch controller 715 may direct the communications to the second DSP device 705b.

The multiple first electronic devices 705 may individually include memory that may be used as a buffer for communications through the multiple first electronic devices 705. The memory in the multiple first electronic devices 705 may be utilized to buffer incoming and/or outgoing traffic, which may include in-band traffic 720 and/or out-of-band traffic 725. Due to the memory in the multiple first electronic devices 705 being distributed (e.g., by the distributed nature of the multiple first electronic devices 705), the switch device 700b may not include any memory for buffering in addition to the memory included in the multiple first electronic devices 705.

The multiple first electronic devices 705 may individually include one or more additional lanes that may be used for communications in the switch device 700b. Further details associated with the additional lanes are included in the description associated with FIG. 7C.

The multiple second electronic devices 710 may individually include one or more ports that may be used to facilitate communications within the switch device 700b, similar to the ports described relative to the multiple first electronic devices 705. Alternatively, or additionally, the lanes for communications between the multiple first electronic devices 705 and the multiple second electronic devices 710 may be coupled with the ports included in the multiple second electronic devices 710.

The switch controller 715 may be a microcontroller unit (MCU). Alternatively, or additionally, the switch controller 715 may be a DSP, or other processing device. The switch controller 715 may be communicatively coupled with at least the multiple first electronic devices 705 and/or the multiple second electronic devices 710. The switch controller 715 may resolve resource grant requests, distribute the network state to the multiple first electronic devices 705 and/or to the multiple second electronic device 710, and/or may establish and/or maintain timing among the components included in the switch device 700b.

The switch controller 715 may communicate with the multiple first electronic devices 705 and/or the multiple second electronic devices 710 using a separate connection/lane than the connections between the multiple first electronic devices 705 and the multiple second electronic devices 710. For example, the first connection between the multiple first electronic devices 705 and the multiple second electronic devices 710 may facilitate the in-band traffic

720 and the second connection between the switch controller 715 and the multiple first electronic devices 705 and/or the multiple second electronic devices 710 may facilitate the out-of-band traffic 725.

The out-of-band traffic 725 may use a different network than the in-band traffic 720. Alternatively, or additionally, the out-of-band traffic 725 may use a different physical layer protocol than the in-band traffic 720. The out-of-band traffic 725 may be used to manage and/or configure one or more components included in the switch device 700b. For example, the switch controller 715 may communicate with the multiple first electronic devices 705 using the out-of-band traffic 725 to reconfigure lanes and/or traffic routing based on the traffic through the switch device 700b.

The switch controller 715 may be programmable such that the switch controller 715 may be operable to dynamically map the lanes between the multiple first electronic devices 705 and the multiple second electronic devices 710. For example, in instances in which the first DSP device 705a includes a lane to the first analog IC 710a, the switch controller 715 may dynamically map the lane to be from the first DSP device 705a to the second analog IC 710b. The switch controller 715 may dynamically adapt the mapping of the lanes between the multiple first electronic devices 705 and the multiple second electronic devices 710 based on one or more conditions and/or a satisfaction of a threshold related to the conditions. For example, in instances in which the real-time data traffic in the switch device 700b (or an amount of real-time data traffic handled by one of the multiple first electronic devices 705 and/or one of the multiple second electronic devices 710) satisfies a threshold, the switch controller 715 may dynamically adapt the mapping of the lanes as described.

The switch device 700b may include one or more redundant lanes that may be used in various situations during operation of the switch device 700b. For example, one or more redundant lanes may be used for the out-of-band traffic 725, such as signaling using the out-of-band traffic 725. In such instances, the out-of-band signaling may be transmitted and/or received by a particular DSP device and/or by the switch controller 715, and the out-of-band signaling may be a lower transmission rate than the in-band traffic 720. In another example, one or more redundant lanes may be used for out-of-bandwidth broadcasts from the switch controller 715 and/or from one or more of the multiple first electronic devices 705 to other devices in the switch device 700b (e.g., such as other DSP devices).

The switch controller 715 may reserve a portion of bandwidth associated with the in-band traffic 720 in the switch device 700b. The bandwidth reserved by the switch controller 715 may be reserved on a per lane basis of the multiple lanes included in the switch device 700b. For example, a first lane between the first DSP device 705a and the first analog IC 710a may have a first reserved bandwidth and a second lane between the second DSP device 705b and the second analog IC 710b may have a second reserved bandwidth, where the amount of bandwidth reserved may be the same or may differ between the first reserved bandwidth and the second reserved bandwidth. The switch controller 715 may allocate resources within the switch device 700b based on predicted or anticipated traffic (e.g., based on a probabilistic model).

Alternatively, or additionally, the switch controller 715 may monitor the lanes of the multiple lanes in the switch device 700b. The switch controller 715 may monitor the multiple lanes periodically and/or in a round robin manner, such that the lanes of the multiple lanes may observed to determine if failures or degradations may be present in a lane. In instances in which a lane experiences a degradation that satisfies a threshold for an acceptable loss, the switch controller 715 may dynamically remap a new lane in the switch device 700b to replace the degraded lane.

The switch controller 715 may perform adaptive signal equalization to the in-band traffic 720 in the switch device 700b. For example, the multiple first electronic devices 705 may provide feedback to the switch controller 715 relative to the workload handled by the multiple first electronic devices 705, and the switch controller 715 may adaptively manage workloads of the multiple first electronic devices 705 to optimize performance of the switch device 700b.

A backup switch controller (not illustrated) may be included in the switch device 700b. The backup switch controller may be a redundant controller relative to the switch controller 715. The backup switch controller may include the same or similar connections as the switch controller 715 relative to the multiple first electronic devices 705 and/or the multiple second electronic devices 710. The backup switch controller may perform the same or similar operations as the switch controller 715.

FIG. 7C illustrates an example switch device 700c. The switch device 700c may include a first DSP device 705a, an nth DSP device 705c, and multiple analog ICs 735. The first DSP device 705a may include a first auxiliary channel 707a, and a first out-of-band channel 709a. The nth DSP device 705c may include an nth auxiliary channel 707c, and an nth out-of-band channel 709c.

The first DSP device 705a, the nth DSP device 705c, and the multiple analog ICs 735 may be the same or similar as the first DSP device 705a, the nth DSP device 705c, and the multiple second electronic devices 710, respectively, of FIG. 7A and may be operable to perform the same or similar functions as described.

The auxiliary channels 707 (e.g., the first auxiliary channel 707a and the second auxiliary channel 707c) may be individually utilized by each of the DSP devices 705a, 705c as an additional lane for in-band traffic between at least the DSP devices 705a, 705c and the multiple analog ICs 735. The auxiliary channels 707 may be used to redundantly transmit in-band traffic relative to another lane included in the DSP devices 705a, 705c prior to a change in configuration to the corresponding DSP devices 705a, 705c. For example, in instances in which the first DSP device 705a includes a lane to a particular analog IC of the multiple analog ICs 735 and the first DSP device 705a is to be reconfigured (e.g., by a switch controller as described herein), the first auxiliary channel 707a may have a lane mapped to the particular analog IC such that the in-band traffic is redundant between the first DSP device 705a and the particular analog IC prior to reconfiguring the lanes associated with the first DSP device 705a (which reconfiguration may otherwise break the connection between the first DSP device 705a and the particular analog IC).

The auxiliary channels 707 may be used for communication between other near DSP devices. For example, in instances in which the first DSP device 705a is disposed spatially near to the nth DSP device 705c, the first DSP device 705a and the nth DSP device 705c may communicate with one another via the auxiliary channels 707. Such communications may be possible as the channels between near-neighbors may be relatively clean, such that physical layer processing may be simplified and may result in power reduction, latency reduction, a lesser amount of equalization, and/or other benefits to the switch device 700c.

The out-of-band channels 709 may be used to communicate the out-of-band traffic (e.g., the out-of-band traffic 725 of FIG. 7B) on a lane separate from the multiple lanes used to communicate in-band traffic. In such instances, the out-of-band channels 709 may not cause blocking or interference to the in-band traffic between at least the DSP devices 705a, 705c and the multiple analog ICs 735.

FIG. 7D illustrates an example aggregated switch device 700d. The aggregated switch device 700d may include a first switch device 700aa, an nth switch device 700ac, and multiple analog crossbar switches 740. The first switch device 700aa and the nth switch device 700ac may individually be the same or similar as the switch device 700b of FIG. 7B.

The aggregated switch device 700d illustrates that any number of the switch devices 700b (e.g., the first switch device 700aa and the nth switch device 700ac) may be aggregated into another switch device and/or connected to other analog crossbar switches. Each of the switch devices 700b may include multiple DSP devices and multiple analog IC and may be further aggregated into the aggregated switch device 700d using the multiple analog crossbar switches 740. As such, the aggregated switch device 700d may be scaled up or down for any size communication need, by adjusting the switch devices 700b and/or the multiple analog crossbar switches 740 to meet the communication demand.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

1. A circuit for selectively retiming input signals, the circuit comprising:
an input crossbar configured to receive a plurality of input signals and selectively route a subset of the input signals for retiming, wherein the subset is determined based on signal quality assessments;
one or more retimers coupled to the input crossbar, the one or more retimers configured to recondition a subset of input signals to compensate for high-loss channels;
an output crossbar configured to route the retimed signals and bypassed signals to corresponding output channels;
wherein the circuit further includes a controller configured to: determine a channel quality by utilizing a sniffer to evaluate signal conditions of the input signals; and adjust, based on the channel quality, routing configurations within the input crossbar and output crossbar, such that low-loss channels bypass the one or more retimers.

2. The circuit of claim 1, wherein the input crossbar is configured to dynamically route input signals using real-time control signals received from a switch controller.

3. The circuit of claim 1, wherein the sniffer evaluates channel conditions by tapping into an input signal path without disrupting ongoing data transmission.

4. The circuit of claim 1, wherein the retimers include an out-of-band (OOB) transceiver configured to communicate channel quality metrics to a controller.

5. The circuit of claim 1, wherein a control mechanism employs a time-division multiplexing (TDM) protocol to prioritize high-risk channels for sniffing operations.

6. The circuit of claim 1, wherein the output crossbar includes a redundant crossbar configured to maintain signal routing during failover events.

7. The circuit of claim 1, wherein the input crossbar is configured to support simultaneous routing of bypassed and retimed signals.

8. The circuit of claim 1, wherein a system minimizes power consumption by reducing a frequency of sniffing operations for channels with historically low-loss metrics.

9. The circuit of claim 1, wherein the sniffer is configured to evaluate input channels periodically in a duty-cycled manner.

10. A system comprising:
an advanced electrical circuit switch (AECS) comprising:
one or more digital signal processors (DSPs), the DSPs configured to include:
an M x Line Rx module for receiving input signals;
an M x Line Tx module for transmitting output signals;
a DSP crossbar for routing signals within the DSP;
one or more analog crossbars configured to route signals between the DSPs;
a plurality of retimers integrated within the AECS, the retimers configured to:
dynamically assess signal quality of input channels using a sniffing mechanism; and
selectively recondition signals based on channel conditions; and
a management plane configured to communicate with the DSPs and analog crossbars via out-of-band (OOB) signaling to control channel routing and retiming operations,
wherein the system further includes a redundant crossbar architecture configured to maintain fault tolerance and uninterrupted communication during failover events.

11. The system of claim 10, wherein the AECS is configured to support high-performance applications including PCIe repeaters, DSP interconnects, and active cable systems.

12. The system of claim 10, wherein the analog crossbars include an OOB transceiver configured to communicate with the management plane for dynamic channel configuration.

13. The system of claim 10, wherein the redundant crossbar architecture enables uninterrupted communication using failover paths during signal degradation or hardware failure.

14. The system of claim 10, wherein the DSPs include auxiliary in-band transceivers for nearest-neighbor communication using a separate wire for auxiliary IB lanes.

15. The system of claim 10, wherein the management plane is configured to facilitate resource allocation using out-of-band (OOB) signaling.

16. The system of claim 10, wherein the OOB signaling employs inter-integrated circuit (I2C) or serial peripheral interface (SPI) protocols to synchronize channel routing operations.

17. The system of claim 10, wherein the retimers are configured to dynamically adjust power consumption by selectively enabling or disabling channels based on real-time traffic conditions.

18. A method for selectively retiming input channels in a repeater circuit, comprising:
receiving a plurality of input signals at an input crossbar;
dynamically assessing signal quality of the input signals by:
sequentially connecting a sniffer to input signals in a round-robin manner, wherein the sniffer evaluates channel metrics including one or more of signal-to-noise ratio (SNR), bit error rate (BER), and jitter;
comparing the channel metrics to predefined thresholds to determine whether retiming is used;
routing a subset of input signals exceeding the predefined thresholds through one or more retimers for reconditioning;
bypassing low-loss channels directly through the input crossbar to an output crossbar without retiming;
transmitting the retimed and bypassed signals through the output crossbar to corresponding output channels;
receiving feedback from output channels via in-band (IB) signaling or out-of-band (OOB) communication to confirm and refine channel assessments; and
dynamically reconfiguring the routing within the input and output crossbars based on the feedback.

19. The method of claim 18, wherein the sniffer is configured to analyze eye diagrams of input signals to detect high-frequency attenuation and reflections.

20. The method of claim 18, wherein a round-robin mechanism adjusts a duty cycle of sniffing operations based on traffic patterns, assigning higher priority to high-risk channels.
